(19) United States
(12) Patent Application Publication
(10) Pub. No.: US 2009/0284433 A1
(43) Pub. Date: Nov. 19, 2009

(54) ANTENNA DEVICE AND MOBILE TERMINAL DEVICE

(75) Inventors: Yukako Tsutsumi, Yokohama-Shi (JP); Masaki Nishio, Tokyo (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/465,075

(22) Filed: May 13, 2009

(30) Foreign Application Priority Data
May 16, 2008 (JP) 2008-129786

(51) Int. Cl. H01Q 9/04; H01Q 1/50; H01Q 1/36

(52) U.S. Cl. 343/825; 343/850; 343/700 MS

(57) ABSTRACT

There is provided with an antenna device provided on a board, which includes: a first linear element 6; a feed element 4; a ground element 5; a second linear element 7 and a third linear element 8 arranged in parallel with each other; a fourth linear element 9; a fifth linear element 10; and a sixth linear element 11. A first radiating element is formed of the first linear element 6 and the feed element 4, and the second radiating element is formed of a portion of the feed element 4, a portion of the ground element 5, and the second, third, fourth, fifth, and sixth linear elements 7-11.

### CROSS REFERENCE TO RELATED APPLICATIONS

This application is based upon and claims the benefit of priority from the prior Japanese Patent Application No. 2008-129786, filed on May 16, 2008, the entire contents of which are incorporated herein by reference.

### BACKGROUND OF THE INVENTION

1. Field of the Invention

The present invention relates to an antenna device and a mobile terminal device.

2. Related Art

An antenna used in a terminal device such as a cellular phone to communicate by radio is required to operate at a plurality of frequencies in order to support various applications. The antenna is also required to be incorporated in the device to make the volume occupied by the antenna as small as possible, since the antenna arranged outside the device spoils the design quality and compact form of the device. However, there is a problem that the characteristics of the antenna deteriorate when the antenna is arranged near a board to be incorporated in the device. JP-A 2007-181046 (Kokai) discloses a technique to solve the problem as stated below.

JP-A 2007-181046 (Kokai) discloses an antenna having a first element which operates with being connected to a feeding point, and a second element which is connected to a ground point while being arranged near the first element to operate through coupling feed. The antenna operates at one or both of a frequency f1 and a frequency f2, the frequency f2 being higher than the frequency f1. The second element resonates at the frequency f1 while a set of the first and second elements resonate at the frequency f2, by which two resonance operations can be obtained. When the resonance occurs at the frequency f2, electric current converges in an antenna element, which leads to the characteristic that the antenna provided to a radio communication device such as a cellular phone is hardly affected by a human body. Therefore, it is possible to incorporate the antenna entirely in a housing.

However, the above conventional antenna has a monopole structure in which the first element is connected at its end to the feeding point while the second element is connected at its end to the ground point. Therefore, when the antenna is arranged within the housing with having a low profile, the elements are arranged near the board and the electric current converges in the feeding point, which leads to the problem that impedance becomes low and impedance matching cannot be achieved. Further, the resonance at the frequency f1 is caused by the electric current flowing into the second element, while the resonance at the frequency f2 is caused by the electric current flowing into the first and the second elements. Therefore, there is another problem that the resonance frequencies f1 and f2 cannot be controlled independently, which means that the antenna cannot operate at a plurality of arbitrary frequencies.

### SUMMARY OF THE INVENTION

According to a first aspect of the present invention, there is provided with an antenna device provided on a board, comprising:

a first linear element arranged along a first portion of outer circumferential sides of the board;

a feed element whose one end is connected to the first linear element and whose other end is connected to a feeding point of the board;

a ground element whose one end is connected to one end of the first linear element and whose other end is connected to the board;

a second linear element and a third linear element arranged in parallel with each other along a second portion of the outer circumferential sides of the board;

a fourth linear element whose one end is connected to one end of the second linear element and whose other end is connected between the one end and the other end of the feed element;

a fifth linear element whose one end is connected to one end of the third linear element and whose other end is connected between the one end and the other end of the ground element, the one end of the third linear element being situated on the same side as the one end of the second linear element; and

a sixth linear element whose one end is connected to the other end of the second linear element and whose other end is connected to the other end of the third linear element,

wherein a first radiating element is formed of the first linear element and the feed element,

wherein a second radiating element is formed of a feed element portion from the other end of the feed element to a connection point of the feed element with one end of the fourth linear element, a ground element portion from the other end of the ground element to a connection point of the ground element with one end of the fifth linear element, and the second, third, fourth, fifth, and sixth linear elements, and

wherein the first radiating element has a length to resonate at a first frequency, while the second radiating element has a length to resonate at a second frequency, the first frequency and the second frequency being different from each other.

According to a second aspect of the present invention, there is provided with a mobile terminal device comprising an antenna device according to the first aspect of the invention, wherein the mobile terminal device communicates through the antenna device.

### BRIEF DESCRIPTION OF THE DRAWINGS

FIG. 1 is a diagram showing a schematic structure of an antenna device according to a first embodiment of the present invention.

FIG. 2 is a diagram showing the part which operates at a frequency f1 in the antenna device of FIG. 1.

FIG. 3 is a diagram showing the part which operates at a frequency f2 in the antenna device of FIG. 1.

FIG. 4 is an enlarged view showing an area around a feeding unit 2 of FIG. 2.

FIG. 5 is an enlarged view showing an area around the feeding unit 2 of FIG. 3.

FIG. 6 is a diagram showing VSWR of the antenna device of FIG. 1 based on a result of electromagnetic field simulation.

FIG. 7 is a diagram showing VSWR of the antenna structure of FIG. 2 based on a result of electromagnetic field simulation.

FIG. 8 is a diagram showing VSWR of the antenna structure of FIG. 3 based on a result of electromagnetic field simulation.

FIG. 9 is a diagram showing another example of the antenna device according to the first embodiment of the present invention.

FIG. 10 is a diagram showing a schematic structure of an antenna device according to a second embodiment of the present invention.

FIG. 11 is a diagram showing a schematic structure of an antenna device according to a third embodiment of the present invention.

FIG. 12 is a diagram showing a schematic structure of an antenna device according to a fourth embodiment of the present invention.

FIG. 13 is a diagram showing VSWR of the antenna device of FIG. 12 based on a result of electromagnetic field simulation.

FIG. 14 is a diagram showing the gross efficiency of the antenna device of FIG. 12 based on a result of electromagnetic field simulation.

FIG. 15 is a diagram showing a schematic structure of a radio device according to a fifth embodiment of the present invention.

### DETAILED DESCRIPTION OF THE INVENTION

Hereinafter, embodiments of the present invention will be explained in detail with reference to the drawings.

### First Embodiment

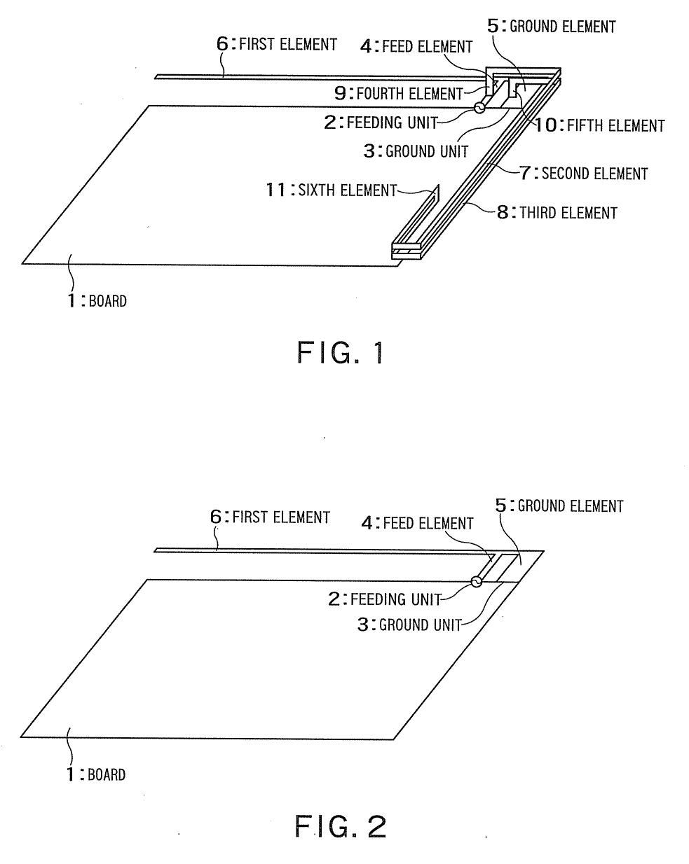

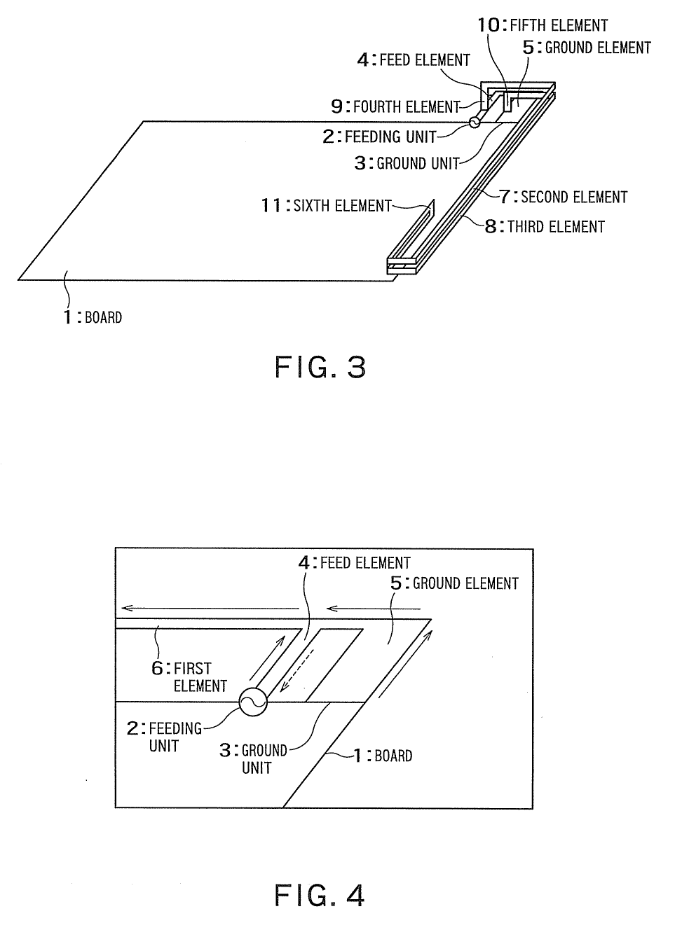

FIG. 1 is a diagram showing a schematic structure of an antenna device according to a first embodiment of the present invention. Each of FIG. 2 and FIG. 3 is a diagram showing a part obtained by separating the antenna device of FIG. 1 into two.

The antenna device of FIG. 1 is attached to a board 1 formed of a conductive material. A circuit element, wiring, etc. can be arranged on the board 1 incorporated in the device.

Particularly as shown in FIG. 2, the antenna device of FIG. 1 includes: a first element (first linear element) 6 arranged along a first portion of outer circumferential sides of the board 1; a feed element 4 whose one end is connected to the first element 6 and whose other end is connected to a feeding unit (feeding point) 2 on the board 1; and a ground element 5 whose one end is connected to one end of the first element 6 and whose other end is connected to a ground unit 3 on the board 1. The other end of the first element 6 is an open end. A first radiating element is formed of the first element 6 and the feed element 4.

Further, particularly as shown in FIG. 3, the antenna device of FIG. 1 includes: a second element (second linear element) 7 and a third element (third linear element) 8 arranged in parallel with each other along a second portion of the outer circumferential sides of the board 1; a fourth element (fourth linear element) 9 whose one end is connected to one end of the second element 7 and whose other end is connected between the one end and the other end of the feed element 4; a fifth element (fifth linear element) 10 whose one end is connected to one end of the third element 8 and whose other end is connected between the one end and the other end of the ground element 5, the one end of the third element 8 being situated on the same side as the one end of the second element 7; and a sixth element 11 whose one end is connected to the other end of the second element 7 and whose other end is connected to the other end of the third element 8. A second radiating element is formed of: a portion of the feed element 4 from the other end of the feed element 4 to the connection point of the feed element 4 and the fourth element 9; a portion of the ground element 5 from the other end of the ground element 5 to the connection point of the ground element 5 and the fifth element 10; the second element 7; the third element 8; the fourth element 9; the fifth element 10; and the sixth element 11.

The first radiating element has a length to resonate at a first frequency f1, while the second radiating element has a length to resonate at a second frequency f2, the first frequency and the second frequency being different from each other. In this example, the first radiating element has a length of approximately one-quarter wavelength of the first frequency f1, while the second radiating element has a length of approximately one-half wavelength of the second frequency f2.

A wire, a strip line, etc. formed of a metal such as copper, aluminum, silver, and gold are used to form the feed element 4, the ground element 5, the first element 6, the second element 7, the third element 8, the fourth element 9, the fifth element 10, and the sixth element 11.

The antenna device of FIG. 1 operates at two independent frequencies f1 and f2, and can easily achieve impedance matching at each frequency. Hereinafter, the operation of the antenna device of FIG. 1 will be explained.

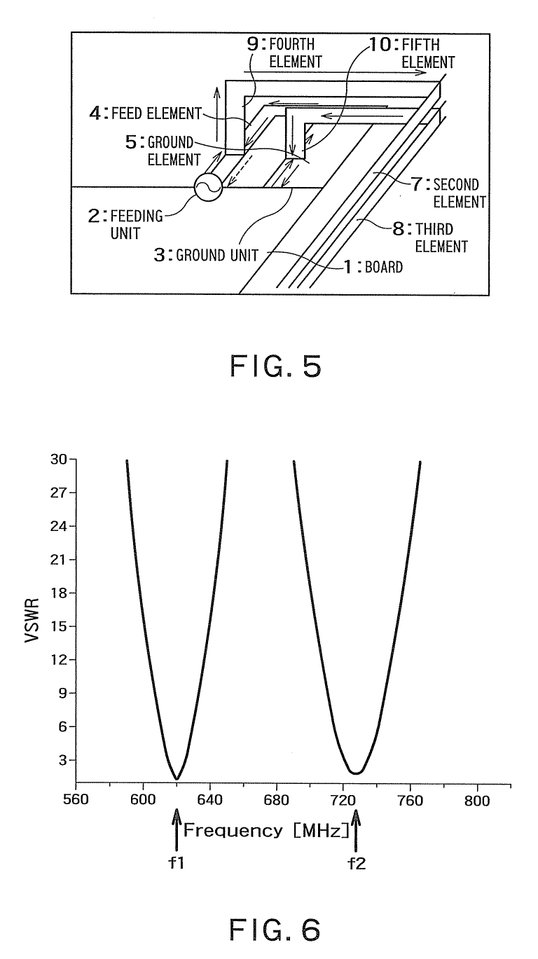

FIG. 4 is an enlarged view showing an area around the feeding unit 2 of FIG. 2, while FIG. 5 is an enlarged view showing an area around the feeding unit 2 of FIG. 3. In these drawings, an arrow expresses the flow of electric current.

In FIG. 2, when the first element 6 is arranged near the board 1 without the ground unit 3 and the ground element 5, the electric current converges in the area around the feeding unit 2, by which the input impedance of the antenna device decreases and the impedance matching cannot be achieved. On the other hand, when the ground unit 3 and the ground element 5 are arranged as in the first embodiment, bypass current flows into the ground element 5 to further flow into the feed element 4 as shown in FIG. 4, by which the electric current in the area around the feeding unit 2 is counteracted (the electric current flowing into the feed element 4 as the bypass current is shown by a broken line). Accordingly, the convergence of the electric current in the area around the feeding unit 2 is restrained, by which the impedance increases and the impedance matching can be achieved. The antenna formed as shown in FIG. 2 is generally called an inverted-F antenna.

In FIG. 3, when the second element 7 and the third element 8 are arranged near the board 1 without the ground unit 3 and the ground element 5, the electric current converges in the area around the feeding unit 2, by which the input impedance of the antenna device decreases and the impedance matching cannot be achieved. On the other hand, when the ground unit 3 and the ground element 5 are arranged as in the first embodiment, the bypass current flows into the ground element 5 to further flow into the feed element 4 as shown in FIG. 5, by which the electric current in the area around the feeding unit 2 is counteracted (the electric current flowing into the feed element 4 as the bypass current is shown by a broken line). Accordingly, the convergence of the electric current in the area around the feeding unit 2 is restrained, by which the impedance increases and the impedance matching can be achieved. Further, since the ground element 5 is diverged by the fifth element 10 to be connected to the third element 8, the electric current flowing from the third element 8 into the ground element 5 is added to the bypass current and a greater bypass current can be obtained. Therefore, the electric current in the area around the feeding unit 2 is counteracted more effectively and the impedance can be further increased. Accordingly, the second element 7 and the third element 8 can be arranged near the board 1 with having a low profile.

As stated above, since the ground unit 3 and the ground element 5 form a matching element to operate at two of the frequencies f1 and f2, and the ground element 5 is diverged to be connected to a folded-back portion of the part formed of the second element 7, the third element 8, the fourth element 9, the fifth element 10, and the sixth element 11, the impedance matching can be achieved even when the antenna element is arranged extremely near the board. That is, even when each of the first and second radiating elements is arranged extremely near the board with having a low profile, the ground element operates at the first and second frequencies as the matching element to counteract the electric current converging in the feeding unit, by which the impedance matching can be easily achieved at the first and second frequencies by adjusting the form of the ground element and the position of the ground unit.

Therefore, even when the device has a little space within a housing, it is possible to provide an antenna device which has two independent resonance characteristics without deteriorating impedance characteristics, and operates at two arbitrary frequencies at the same time. That is, the resonance occurs at each of the first frequency and the second frequency, and the resonance frequencies can be controlled independently.

Further, since the first radiating element has a length of approximately one-quarter wavelength of the first frequency while the second radiating element has a length of approximately one-half wavelength of the second frequency, the electric current can be distributed effectively.

FIG. 6 is a diagram showing VSWR (voltage standing wave ratio) of the antenna device of FIG. 1 based on a result of electromagnetic field simulation under the condition where the size of the board is 110 mm×65 mm, the distance (shortest distance) between the board 1 and the first element 6 is approximately 9 mm, and the distance (shortest distance) between the board 1 and the third element 8 is approximately 3 mm.

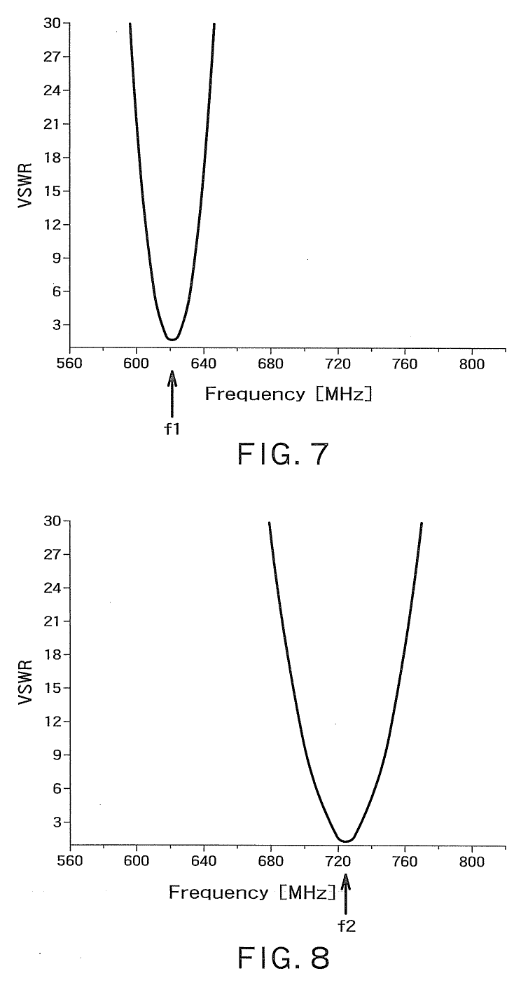

FIG. 7 is a diagram showing VSWR of the antenna structure of FIG. 2 while FIG. 8 is a diagram showing VSWR of the antenna structure of FIG. 3, each being based on a result of electromagnetic field simulation under the same condition as in FIG. 6.

The frequencies (f1 and f2) at which VSWR decreases in FIG. 6 are nearly the same as the frequency (f1) at which VSWR decreases in FIG. 7 and the frequency (f2) at which VSWR decreases in FIG. 8. Therefore, it is verified that the part of FIG. 2 and the part of FIG. 3 operate independently without affecting each other in the antenna device of FIG. 1. It is also verified that VSWR decreases at the frequencies f1 and f2 when the first element 6 and the third element 8 are arranged with a short distance of approximately one-50th wavelength (approximately 9 mm) and approximately one-140th wavelength (approximately 3 mm) from the board 1, respectively.

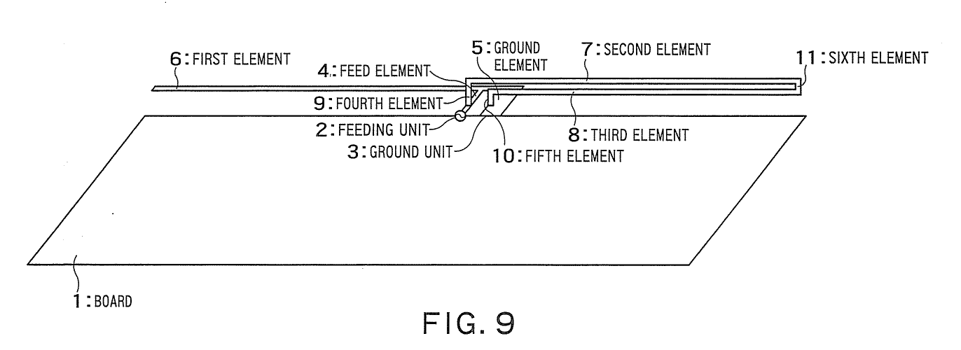

In the antenna device of FIG. 1, the second element 7 and the third element 8 have a folded form. However, as shown in FIG. 9, the second element 7 and the third element 8 can also have a linear form.

Further, the first element 6, the second element 7, the third element 8, the fourth element 9, the fifth element 10, and the sixth element 11 can also have a meander form, a helical form, or a coil form.

### Second Embodiment

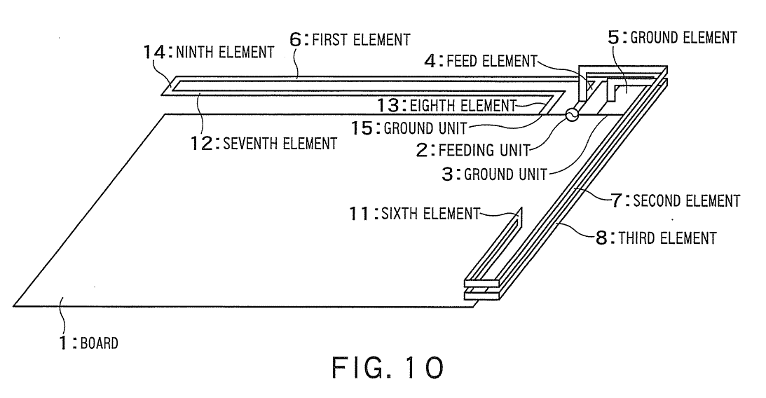

FIG. 10 is a diagram showing a schematic structure of an antenna device according to a second embodiment of the present invention.

A seventh element 12, an eighth element 13, and a ninth element 14 are added to the antenna device of FIG. 1.

More specifically, this antenna device additionally includes: the seventh element 12 arranged in parallel with the first element 6; the eighth element 13 whose one end is connected to one end of the seventh element and whose other end is connected to a ground unit 15 of the board 1, the one end of the seventh element being situated on the same side as one end of the first element 6; and the ninth element 14 whose one end is connected to the other end of the first element 6 and whose other end is connected to the other end of the seventh element 12.

A wire, a strip line, etc. formed of a metal such as copper, aluminum, silver, and gold are used to form the seventh element 12, the eighth element 13, and the ninth element 14.

In this antenna device, the first radiating element is formed of the feed element 4, the first element 6, the seventh element 12, the eighth element 13, and the ninth element 14. The first radiating element in the second embodiment has a length of approximately one-half wavelength of the first frequency. The second radiating element is formed of the similar elements as in the first embodiment, and has a length of approximately one-half wavelength of the second frequency.

The first radiating element (the first element 6, the seventh element 12, the eighth element 13, the ninth element 14, and the feed element 4) has a folded structure to be connected to the ground unit 15 through the end of the eighth element 13, and has an entire length of approximately one-half wavelength of the first frequency f1, by which the electric current flowing into the eighth element 13 from the ground unit 15 is separated from the electric current flowing into the feed element 4. Accordingly, the input impedance at the first frequency f1 is made greater than that in the antenna device of FIG. 1, by which the deterioration in VSWR is smaller than that in the antenna device of FIG. 1 when the first radiating element is arranged near the board 1. Note that since the antenna device of FIG. 10 operates similarly as the antenna device of FIG. 1, the explanation thereof will be omitted.

As in the first embodiment, the second element 7 and the third element 8 can have a linear form instead of a folded form.

Further, the part formed of the first element 6, the seventh element 12, the eighth element 13, and the ninth element 14 and the part formed of the second element 7, the third element 8, the fourth element 9, the fifth element 10, and the sixth element 11 can also have a meander form, a helical form, or a coil form.

Having a folded form, the first radiating element in the second embodiment is more complicated than that in the first embodiment. However, the input impedance at the first frequency increases, and the first radiating element can be arranged nearer the board. Further, since the first radiating element has a length of approximately one-half wavelength of the first frequency while the second radiating element has a length of approximately one-half wavelength of the second frequency, the electric current can be distributed effectively.

### Third Embodiment

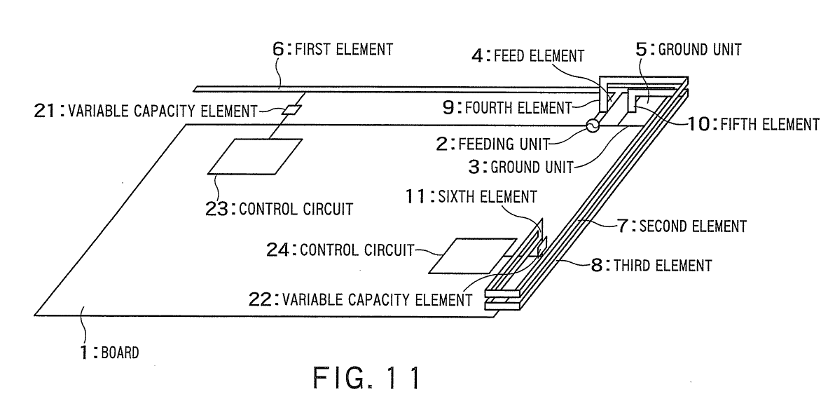

FIG. 11 is a diagram showing a schematic structure of an antenna device according to a third embodiment of the present invention.

The antenna device of FIG. 11 includes: a variable capacity element 21 whose one end is connected to the first element 6 and whose other end is connected (grounded) to the board 1; and a variable capacity element 22 whose one end is connected to the sixth element 11 and whose other end is connected (grounded) to the board 1. The variable capacity elements 21 and 22 are connected to control circuits 23 and 24 respectively, the control circuits 23 and 24 being arranged on the board 1 to control and change the capacity of the variable capacity elements 21 and 22.

In the antenna device of FIG. 11, operating frequencies change in accordance with the capacity values of the variable capacity elements 21 and 22. By adding the capacity to the sixth element 11, the electrical length of a folded-back portion of the part formed of the second element 7, the third element 8, the fourth element 9, the fifth element 10, and the sixth element 11 becomes long, and the operating frequency decreases compared to the case where the capacity is not added. Further, by adding the capacity to the first element 6, the electrical length of the sixth element 11 becomes long, and the operating frequency decreases compared to the case where the capacity is not added. Furthermore, when the capacity values of the variable capacity elements 21 and 22 are increased, the operating frequencies decrease. As stated above, the capacity values of the variable capacity elements 21 and 22 are controlled and changed by the control circuits 23 and 24, by which two resonances can be shifted to desired frequencies and be used at the same time.

Here, when the capacity value added to the antenna element is made large so that the antenna operates at a frequency f′ which is sufficiently lower than a operating frequency f when the capacity value is the minimum value, the wavelength of the frequency f′ is sufficiently longer than the wavelength of the frequency f, which means that the antenna element operates with the size thereof being sufficiently smaller than that of the antenna which resonates at the frequency f′. In such a case, since the size of the antenna element is not large enough for the frequency f′, the electric current cannot be easily transmitted, which deteriorates the efficiency.

Accordingly, by making the antenna device of FIG. 11 operate in the band of the frequency f1 on the low frequency side and in the band of the frequency f2 on the high frequency side separately, the antenna device can operate in a broad frequency band without making the capacity values of the variable capacity elements 21 and 22 large and without deteriorating the efficiency.

As stated above, in the third embodiment, one or both of the frequencies f1 and f2 are changed by capacity control, by which the antenna can operate at desired frequencies without changing the form of the antenna. Further, by making the antenna operate in the band of the frequency f1 on the low frequency side and in the band of the frequency f2 on the high frequency side separately, the antenna can operate in a broad frequency band without making the capacity values of the variable capacity elements large and without deteriorating the efficiency.

### Fourth Embodiment

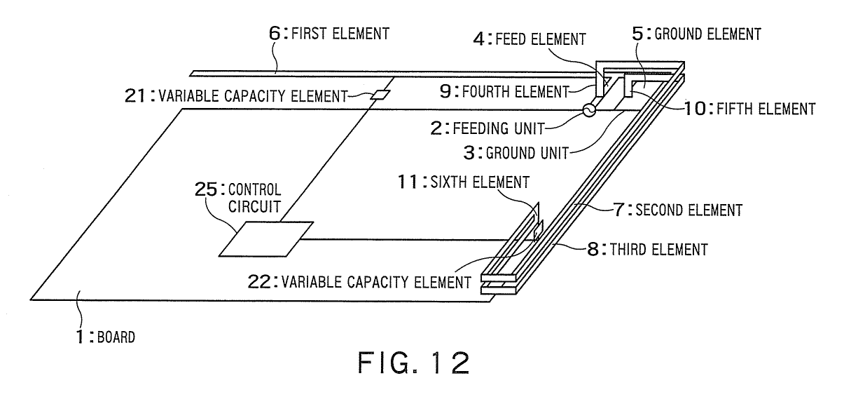

FIG. 12 is a diagram showing a schematic structure of an antenna device according to a fourth embodiment of the present invention.

In the third embodiment, the variable capacity elements 21 and 22 are connected to the control circuits 23 and 24 respectively, while in the fourth embodiment, the variable capacity elements 21 and 22 are commonly connected to a control circuit 25 and are controlled at the same time.

Here, the operating frequencies change not only when the capacity of the variable capacity elements 21 and 22 is changed but also when their arrangement positions are changed, and the amount of change in the frequency with respect to that in the capacity value also changes. Further, by arranging the variable capacity elements 21 and 22 in the portions where potential difference is greater, the effect obtained by adding the capacity values becomes greater, the antenna device operates at a lower frequency, and the amount of change in the frequency with respect to that in the capacity value increases.

Taking the above into consideration, when the antenna device of FIG. 12 operates in the band of the frequency f1 on the low frequency side and in the band of the frequency f2 on the high frequency side separately, and when the variable capacity elements 21 and 22 have the same capacity value and the same variable capacity unit (the capacity value that can be changed at one time) by adjusting the difference between the frequencies f1 and f2 and the positions of the variable capacity elements 21 and 22, the amount of change in the operating frequencies can be the same. Therefore, the variable capacity elements 21 and 22 and can be controlled by the control circuit 25 at the same time instead of being controlled individually, by which the antenna device can operate in a broad frequency band without deteriorating the efficiency. Hereinafter, this operation will be explained in more detail.

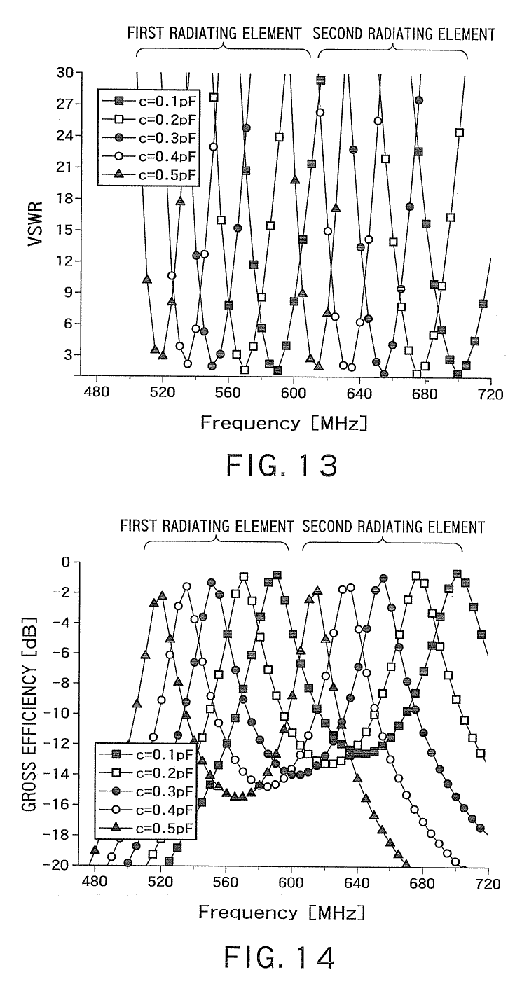

FIG. 13 is a diagram showing VSWR (voltage standing wave ratio) of the antenna device based on a result of electromagnetic field simulation under the condition where the variable capacity element 21 is connected to approximately the midpoint of the first element 6, the variable capacity element 22 is connected to the sixth element 11, the relationship between two of the operating frequencies f1 and f2 when the capacity values of the variable capacity elements 21 and 22 are the minimum values is expressed by f2≅f1+(desired frequency bandwidth for operation)/2, the minimum capacity value of the variable capacity elements 21 and 22 is 0.1 pF, and the variable capacity unit is changed up to 0.5 pF by 0.1 pF. FIG. 14 shows the gross efficiency including matching efficiency and antenna radiation efficiency based on a result of electromagnetic field simulation. Note that, in the antenna device of FIG. 12, the open end of the first element 6 in the first radiating element and the sixth element 11 in the second radiating element have a high voltage.

Referring to FIG. 13 and FIG. 14, it is verified that the antenna device can operate in a broad frequency range of 520 MHz to 700 MHz (fractional bandwidth of 30%) by changing the capacity values of the variable capacity elements 21 and 22 within the range from 0.1 pF to 0.5 pF. When the capacity values of the variable capacity elements 21 and 22 are made gradually large to decrease the operating frequencies, VSWR gradually increases and the gross efficiency gradually decreases, by which antenna characteristics are deteriorated. However, since the antenna device operates at two resonance frequencies on the high frequency side and on the low frequency side separately, it is verified that the gross efficiency on the low frequency side less deteriorates.

In the simulation of FIG. 13 and FIG. 14, since the variable capacity unit of the variable capacity elements 21 and 22 is set 0.1 pF, the antenna characteristics between the adjacent operating frequencies are somewhat deteriorate. However, by making the variable unit smaller, the antenna can operate at every desired frequency bandwidth without deteriorating the antenna characteristics.

### Fifth Embodiment

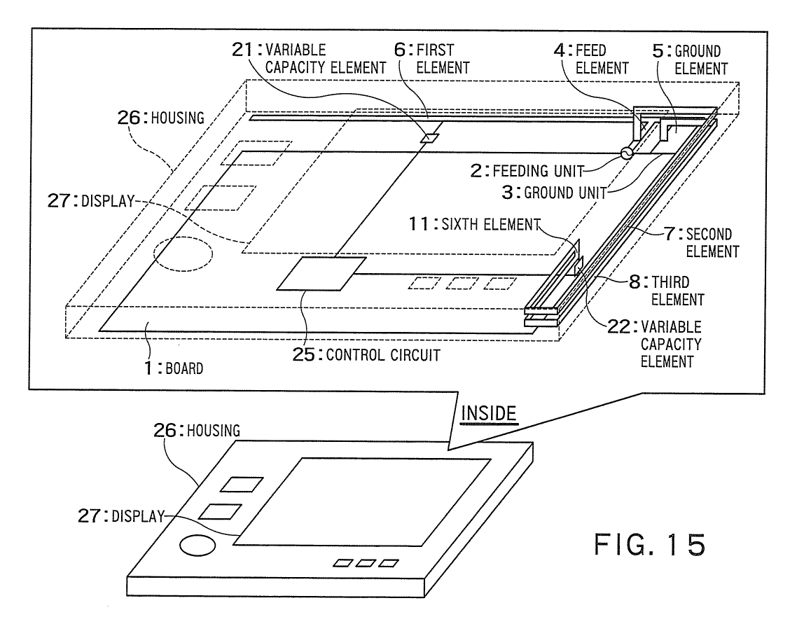

FIG. 15 is a diagram showing a schematic structure of a portable radio device according to a fifth embodiment of the present invention. The portable radio device of FIG. 15 is a device to exchange data, images, video, and sound, and has the antenna device of FIG. 12 therein.

In the device of FIG. 15, a housing 26 has a display 27 to display images etc., and the device communicates by radio through the antenna device of FIG. 12 arranged within the housing 26. For example, the device receives the signal of digital terrestrial television broadcasting through the antenna device of FIG. 12 to display the video on the display 27.

The antenna device of FIG. 12 has two independent resonance characteristics without deteriorating the antenna characteristics at each frequency even when the antenna element is arranged extremely near the board with having a low profile, and can operate in a broad frequency band by changing the capacity values of the variable capacity elements 21 and 22.

Accordingly, even when the antenna device of FIG. 12 is incorporated in the device of FIG. 15, the antenna characteristics do not deteriorate, the degrees of freedom for design can be increased by making the space for the other parts to be arranged within the device large, and the external design is not spoiled by having no need to arrange the antenna device outside the device.

The present invention is not limited to the exact embodiments described above and can be embodied with its components modified in an implementation phase without departing from the scope of the invention. Also, arbitrary combinations of the components disclosed in the above-described embodiments can form various inventions. For example, some of the all components shown in the embodiments may be omitted. Furthermore, components from different embodiments may be combined as appropriate.

What is claimed is:

1. An antenna device provided on a board, comprising:
a first linear element arranged along a first portion of outer circumferential sides of the board;
a feed element whose one end is connected to the first linear element and whose other end is connected to a feeding point of the board;
a ground element whose one end is connected to one end of the first linear element and whose other end is connected to the board;
a second linear element and a third linear element arranged in parallel with each other along a second portion of the outer circumferential sides of the board;
a fourth linear element whose one end is connected to one end of the second linear element and whose other end is connected between the one end and the other end of the feed element;
a fifth linear element whose one end is connected to one end of the third linear element and whose other end is connected between the one end and the other end of the ground element, the one end of the third linear element being situated on the same side as the one end of the second linear element; and
a sixth linear element whose one end is connected to the other end of the second linear element and whose other end is connected to the other end of the third linear element,
wherein a first radiating element is formed of the first linear element and the feed element,
wherein a second radiating element is formed of a feed element portion from the other end of the feed element to a connection point of the feed element with one end of the fourth linear element, a ground element portion from the other end of the ground element to a connection point of the ground element with one end of the fifth linear element, and the second, third, fourth, fifth, and sixth linear elements, and
wherein the first radiating element has a length to resonate at a first frequency, while the second radiating element has a length to resonate at a second frequency, the first frequency and the second frequency being different from each other.

2. The device according to claim 1,
wherein the first radiating element has a length of approximately one-quarter wavelength of the first frequency, and
wherein the second radiating element has a length of approximately one-half wavelength of the second frequency.

3. The device according to claim 1, further comprising:
a seventh linear element arranged in parallel with the first linear element;
an eighth linear element whose one end is connected to one end of the seventh linear element and whose other end is connected to the board, the one end of the seventh linear element being situated on the same side as the one end of the first linear element; and
a ninth linear element whose one end is connected to the other end of the first linear element and whose other end is connected to the other end of the seventh linear element,
wherein the first radiating element is formed of the feed element, the first linear element, and the seventh, eighth, and ninth linear elements,
wherein the first radiating element has a length of approximately one-half wavelength of the first frequency, and
the second radiating element has a length of approximately one-half wavelength of the second frequency.

4. The device according to claim 1, further comprising at least one variable capacity element whose one end is connected to any one of the first to ninth linear elements and whose other end is connected to the board.

5. The device according to claim 4, further comprising a control circuit to control the board and capacity of the variable capacity element.

6. A mobile terminal device comprising an antenna device according to claim 1, wherein the mobile terminal device communicates through the antenna device.
